(19) United States
(12) Patent Application Publication
(10) Pub. No.: US 2015/0138045 A1
(43) Pub. Date: May 21, 2015

(54) VEHICLE HEAD UNIT AND METHOD FOR SETTING SCREEN OF VEHICLE HEAD UNIT

(71) Applicant: HYUNDAI MOBIS CO., LTD., YONGIN-SI (KR)

(72) Inventor: Jae Ick LEE, Yongin-si (KR)

(73) Assignee: HYUNDAI MOBIS CO., LTD., YONGIN-SI (KR)

(21) Appl. No.: 14/087,894

(22) Filed: Nov. 22, 2013

(30) Foreign Application Priority Data
Nov. 15, 2013 (KR) 10-2013-0139073

(51) Int. Cl. G06F 3/14

(52) U.S. Cl. CPC G06F 3/1454; G09G 2340/145; G09G 2380/10
USPC 345/2.2

(57) ABSTRACT

Provided is a vehicle head unit. The vehicle head unit includes: a controller configured to analyze a screen configuration element associated with a preference of a user from a screen image obtained by capturing a screen of a user terminal and create a screen configuration of the vehicle head unit with reference to the analyzed screen configuration element; and a storage unit configured to store the screen configuration of the head unit according to control of the controller.

### CROSS-REFERENCE TO RELATED APPLICATIONS

This application claims priority under 35 U.S.C. §119 to Korean Patent Application No. 10-2013-0139073, filed on Nov. 15, 2013, the disclosure of which is incorporated herein by reference in its entirety.

### TECHNICAL FIELD

The present invention relates to a vehicle head unit, and more particularly, to a method of setting a screen of the vehicle head unit.

### BACKGROUND

Recently, a technology for displaying a screen configuration of a mobile phone, which is set by a user, on a screen of a vehicle head unit embedded with a navigation system has been developed, which is generally referred to as a mirror link technology. The mirror link technology allows a screen of a mobile phone to be displayed in the screen of the vehicle head unit, like a mirror, and may be understood as screen function replication between heterogeneous devices. With the mirror link technology, a user can check and manipulate all kind of mobile applications in the screen of the vehicle head unit. In addition, it is very advantageous that a user can conveniently use a mobile application in a vehicle through the screen of the vehicle head unit that is relatively wide compared to the screen of the mobile phone.

However, since the mirror link technology allows the screen configuration of the mobile phone to be displayed on the screen of the vehicle head unit as it is, it is impossible to display a button or menu for a unique function of the vehicle head unit, a vehicle-specialized function, or a user-specialized function.

Furthermore, in the related art, a size and a resolution of the screen of the mobile phone are different from those of the vehicle head unit. In this case, although the screen configuration of the mobile phone is displayed on the screen of the vehicle head unit as it is when the screen configuration of the mobile phone is delivered to the screen of the vehicle head unit, the screen configuration of the mobile phone has been set to be appropriate for the size and the resolution of the screen of the mobile phone, so that the screen configuration of the mobile phone which is actually seen through the screen of the vehicle head unit is not natural. Inconveniently, a user should set the size and the resolution of the screen of the mobile phone to be suitable for those of vehicle head unit whenever synchronizing the screen of the mobile phone with the screen of the vehicle head unit.

### SUMMARY

Accordingly, the present invention provides a vehicle head unit and a method of setting a screen of the vehicle head unit, which can reduce an inconvenience that the user should newly set the screen of the head unit 200 whenever synchronizing the screen of the head unit with the screen of the use terminal and set a screen configuration specialized to the user.

In one general aspect, a vehicle head unit includes: a controller configured to analyze a screen configuration element associated with a preference of a user from a screen image obtained by capturing a screen of a user terminal and create a screen configuration of the vehicle head unit with reference to the analyzed screen configuration element; and a storage unit configured to store the screen configuration of the head unit according to control of the controller.

In another general aspect, a method of setting a screen of a vehicle head unit includes: analyzing a screen configuration element associated with a preference of a user from a screen image obtained by capturing a screen of the user terminal; and creating a screen configuration of the vehicle head unit using the analyzed screen configuration element.

Other features and aspects will be apparent from the following detailed description, the drawings, and the claims.

### BRIEF DESCRIPTION OF THE DRAWINGS

FIG. 1 is a block diagram showing an entire configuration of a system according to an embodiment of the present invention.

FIG. 2 is a block diagram showing an internal configuration of a vehicle head unit 200 of FIG. 1.

FIGS. 3a to 3c are views showing a process of analyzing a font size of a user terminal to create a screen configuration of a head unit according to an embodiment of the present invention.

FIGS. 4a to 4c are views showing a process of analyzing a font type of a user terminal to create a screen configuration of a head unit according to an embodiment of the present invention.

FIGS. 5 and 6 are views showing a process of analyzing an icon arrangement form of a user terminal to create a screen configuration of a head unit according to an embodiment of the present invention.

FIGS. 7 and 8 are views showing a process of creating a screen of a vehicle head unit using screen configuration elements determined according to an embodiment of the present invention.

FIGS. 9 and 10 are flowcharts showing a method of setting a screen of the vehicle head unit according to an embodiment of the present invention.

### DETAILED DESCRIPTION OF EMBODIMENTS

Hereinafter, embodiments of the present invention will be described in detail with reference to the accompanying drawings.

The present invention proposes a screen synchronization method. Unlike the related art where a vehicle head unit receives a screen configuration of a user terminal and displays the same screen configuration as the received screen configuration, the screen synchronization method according to the present invention analyzes the screen configuration of the user terminal, extracts screen configuration elements based on a user preference, and provides a screen configuration of the vehicle head unit to the user with reference to the extracted screen configuration elements.

It should be noted that the screen synchronization method of the present invention has a different technical concept from a screen synchronization method for displaying the same screen configuration between heterogeneous devices. That is, it should be understood that, unlike the related art where a vehicle head unit receives a screen configuration of a user terminal and displays the same screen configuration as the received screen configuration, the present invention analyzes the screen configuration of the user terminal, extracts a user preference, and provides a screen configuration to be displayed on the head unit with reference to the analyzed user preference.

Hereinafter, exemplary embodiments of the present invention will be described in detail with reference to the accompanying drawings.

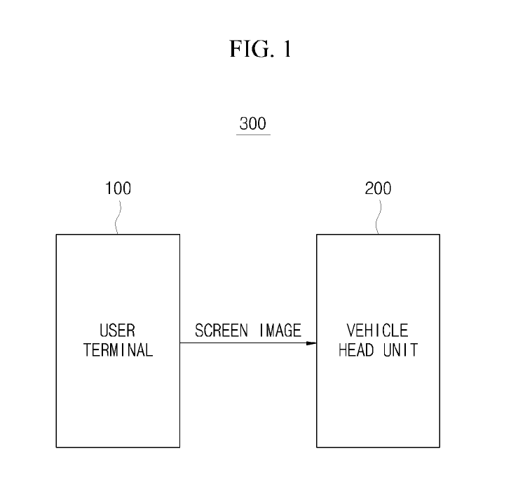

FIG. 1 is a block diagram showing an entire configuration of a system according to an embodiment of the present invention.

Referring to FIG. 1, an entire system 300 according to an embodiment of the present invention includes a user terminal 1000 and a vehicle head unit 200.

The user terminal acquires, as an image, a screen set by a user, and delivers the acquired screen image to the vehicle head unit 200. In order to acquire the screen of the user terminal 100, which is set by the user, as an image, a capture program may be used among a plurality of application programs installed in the user terminal 100. For example, a user may manipulate an interface provided by the user terminal 100 to execute a capture program and acquire as an image a screen that is being currently displayed on the user terminal, using the executed capture program. The acquired image may be delivered to the vehicle head unit 200 via wired or wireless communication. For the wired communication, a USB memory, a connection cable, etc. may be used. For the wireless communication, Bluetooth, WiFi, etc. may be used. Alternatively, the image may be acquired using an image sensor built in the vehicle head unit 200. For example, in order to acquire the image, a user may dispose the display screen of the user terminal 100 in close proximity to the image sensor of the vehicle head unit 200, manipulate an interface provided in the vehicle head unit 200, and then scan (or photograph) the display screen of the user terminal 100. The user terminal 100 may be referred to as a user equipment (UE), a mobile station, an advanced mobile station, a smartphone, a wireless terminal communication device, an M2M device, an MTC device, etc. In addition, examples of the user terminal 100 may include a laptop computer, a network computer, a workstation, a personal digital assistant, a tablet PC, a scanner, a telephone, a camera, a television, a portable video game console rat, a music player, a media player, a wireless sensor, etc.

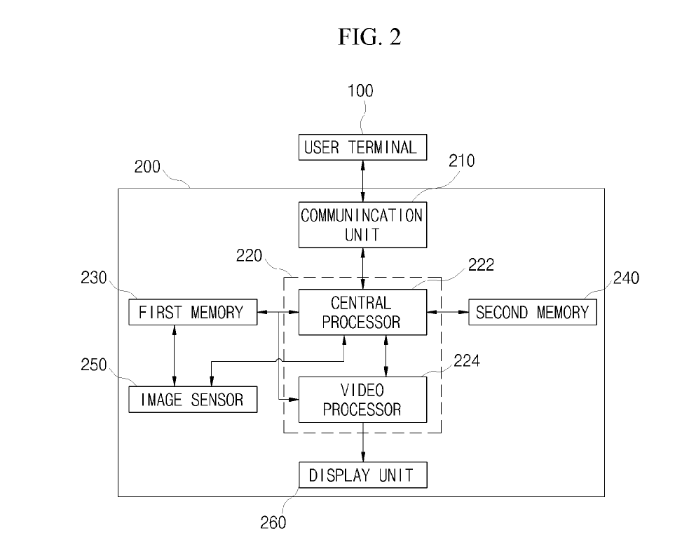

The vehicle head unit 200 analyzes screen configuration elements by analyzing an image provided from the user terminal 100 and creates an screen configuration of the vehicle head unit 200 with reference to the analysis result. Here, each of the screen configuration elements is an element based on a user preference. Examples of the screen configuration element include a color of a button icon, a size of a font, a type of a font, screen brightness, a size of a button icon and font, button arrangement, etc. in a screen of the user terminal 100. The vehicle head unit 200 analyzes screen configuration elements, such as a color of a button icon, a size of a font, a type of a font, screen brightness, a size of a button icon and font, button arrangement, etc, based on a user preference from a screen image provided by the user terminal 100, and defines and creates a screen configuration of the vehicle head unit 200 with reference to the analysis result. A detailed description thereof will be provided with reference to FIG. 2.

FIG. 2 is a block diagram showing an internal configuration of the vehicle head unit 200 of FIG. 1.

Referring to FIG. 2, the vehicle head unit 200 according to an embodiment of the present invention includes a communication unit 210, a controller 220, first and second memories 230 and 240, an image sensor 250, and a display unit 260.

The communication unit 320 is configured to receive a screen image acquired by the user terminal 100 via wired or wireless communication. When the wired communication such as a USB is used, the communication unit 320 may be implemented with a USB interface module. Alternatively, when the wireless communication is used, the communication unit 320 may be implemented with a Bluetooth interface module, a WiFi interface module, an NFC interface module, etc.

The controller 220 analyzes screen configuration elements associated with a preference of the user from a screen image of the user terminal 100 that is received through the communication unit 210 and creates a screen configuration of the vehicle head unit 200 with reference to the analyzed screen configuration elements. To this end, the controller 220 includes a central processor 222 and a video processor 224. The central processor 222 is configured to control and manage entire operations of components 210, 224, 230, 240, 250, and 260 included in the vehicle head unit 200, and specifically extracts screen configuration elements, such as a color of an icon, a background color, a size of an icon and font, a type of a font, screen brightness, a size of an icon, icon arrangement (or form), etc. based on a user preference from a screen image received through the communication unit 210, and delivers the extracted screen configuration elements to the video processor 224. The video processor 224 analyzes the extracted screen configuration elements. In order to create a screen configuration specialized to a user (a head unit or vehicle) on the basis of each of the analyzed screen configuration elements, the video processor 224 creates a layer specialized to a user for each screen configuration element, and completes the created layer as the screen configuration of the vehicle head unit 200. Here, the creating of the layer specialized to a user means, for example, that a layer used as a background color of the screen of the user terminal 100 is changed to a layer used as an icon color of the head unit screen in consideration of a preference of the user or a characteristic of the vehicle (or head unit). That is, the creating of the layer specialized to a user means that an attribute of the screen configuration element analyzed from the screen image of the user terminal 100 is kept constant and that the analyzed screen configuration element is applied to another layer of the head unit screen. The screen configuration of the head unit 200 created (or defined) according to a preference of the user is stored in a memory. As such, by storing the screen configuration of the head unit 200 created according to a preference of the user, it is possible to solve inconvenience of setting the screen of the head unit 200 whenever synchronizing the screen of the head unit 200 with the screen of the use terminal 100. FIG. 2 shows one controller that may be divided into two processors; however, it is the functional division intended to facilitate understanding of the present invention, and thus the controller may be integrated into one processor. For example, the central processor may be built in the video processor and vice versa.

The first memory 230 stores a screen image and screen configuration elements extracted from the screen image according to control of the central processor 222 of the controller 220. The video processor reads and analyzes the screen configuration elements stored in the first memory 230 and creates a screen configuration of the head unit 200.

The second memory 230 stores the screen configuration of the head unit 200 that is created (or defined) by the video processor 224 according to control of the video processor 224 of the controller 220. As such, by storing, in the memory, the screen configuration of the head unit 200 based on the preference of the user, it is possible to solve inconvenience of newly setting the screen.

The display unit 260 is configured to display the screen configuration created by the video processor 224 of the controller 220. An LCD panel capable of detecting a touch input may be used as the display unit 260.

However, the head unit 200 may receive the screen image from the user terminal 100 via wired communication. Alternatively, the head unit 200 may receive the screen image from the image sensor built in the head unit 200. A camera may be used as the image sensor.

Hereinafter, a processing process performed by the controller 220 to create the screen configuration of the head unit 200 will be described in detail. Before the processing process, a process of analyzing three screen configuration elements including a font size, a font type, and an icon arrangement to create the screen configuration of the head unit 200 will be described.

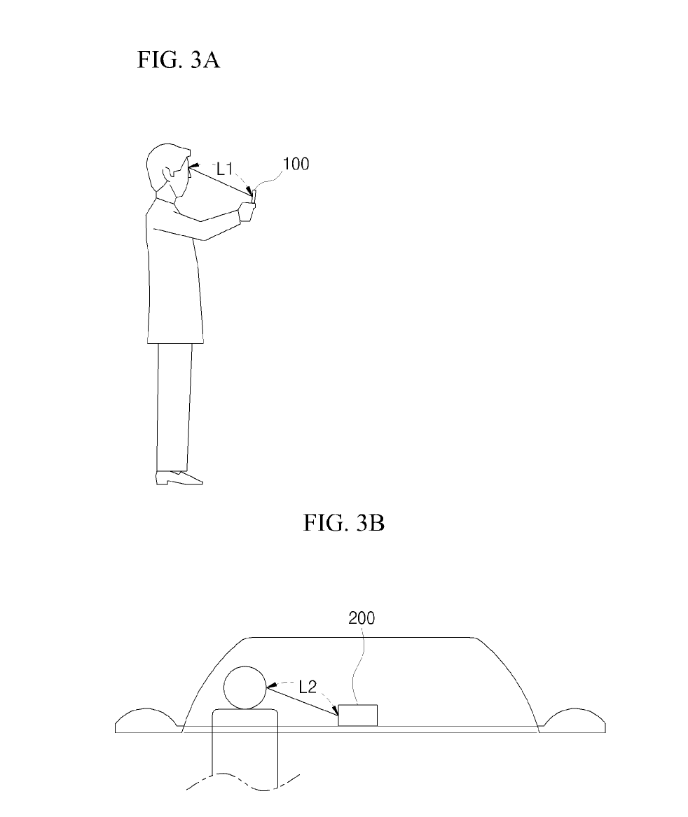

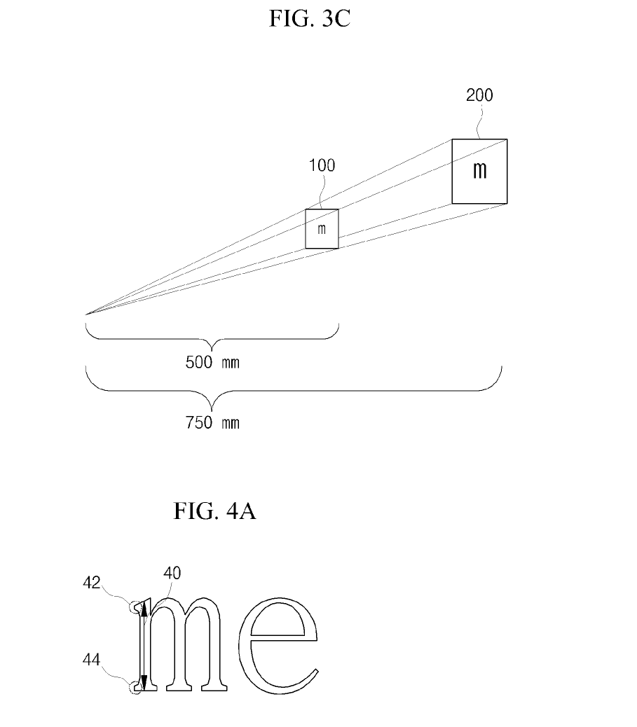

FIGS. 3a to 3c are views showing a process of analyzing a font size of the user terminal 100 to create the screen configuration of the head unit. The description thereof will be provided with reference to FIG. 2.

First, the controller 220 extracts a font object from the screen image provided by the user terminal 100. In order to extract the font object from the screen image, various algorithms may be used. For example, an object extraction algorithm for tracking a boundary of an object included in the image to extract the object may be used. Since the object extraction algorithm is well known in the art, the description thereof will be omitted.

When a font is extracted from the screen image through the object extraction algorithm, the controller adjusts the size of the font according to a predetermined weight. As shown in FIG. 3a, the size of the font may be set in consideration of the distance L1 from eyes of a user who is watching the user terminal 100 to the screen of the user terminal 100. However, the distance from the eyes of a user who is watching the head unit to the head unit screen may be relatively great. That is, as shown in FIG. 3b, the distance L2 from the eyes of the user seated in a driver seat to the screen of the head unit 200 installed inside the vehicle may be greater than the distance L1 of FIG. 3a. Accordingly, the size of the font needs to be adjusted in consideration of the distance L2 of FIG. 3b. To this end, the present invention is characterized in that the controller 220 adjusts the size of the font of the user terminal 100 according to the predetermined weight. Here, the weight is set as a value obtained by quantizing a proportional relation between the average distance L1 from the eyes of the user to the user terminal 100 and the average distance L2 from the eyes of the user to the head unit 200 installed in the vehicle. For example, as shown in FIG. 3, if the size of the font m is set as α in the user terminal 100, the average distance from the eyes of the user to the screen of the user terminal 100 is 500 mm, and the average distance from the eyes of the user to the screen of head unit 200 is 750 mm, then the size of the font m of the user terminal 100 should be adjusted to be 1.5 times greater than α. This may be described as an equation: β=1.5×α. Herein, β is the size of the font m that is to be set in the head unit 200. The font size is defined as a screen configuration element of the head unit 200 and then stored in a memory. The average distance L1 may be a statistical value averaged according to a human body condition and the average distance L2 may be a statistical value averaged according to an installation position of the head unit 200.

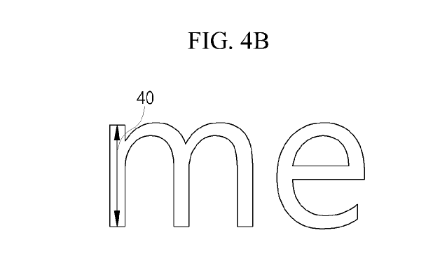

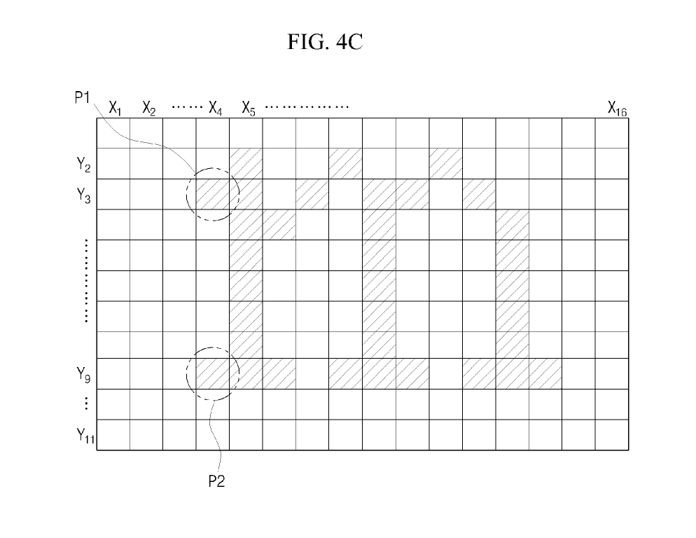

FIGS. 4a and 4b are views showing a process of analyzing a font size of the user terminal 100 to create the screen configuration of the head unit.

Referring to FIGS. 4a and 4b, in an embodiment of the present invention, the font type is largely classified into two in order to analyze the font type based on a preference of the user. Specifically, the controller may analyze whether there are decorations at a starting part and an ending part of a vertical stroke among strokes included in a font object that is included in the screen image provided by the user terminal 100, using an image processing technique, such as an object extraction algorithm, to classify the font type into SERIF and SANS SERIF. For example, a small letter ‘m’ with a decoration at the vertical stroke and a small letter ‘m’ without a decoration at the vertical stroke are shown in FIGS. 4a and 4b, respectively. As shown in FIG. 4a, if the small letter ‘m’ has a protruding decoration at a starting part 42 and/or an ending part 44 of a vertical stroke 40, the controller classifies the font type as SERIF. On the contrary, as shown in FIG. 4b, if the small letter ‘m’ does not have a protruding decoration at a starting part and/or an ending part of a vertical stroke 40, the controller classifies the font type as SERIF. The font type is defined as a screen configuration element of the head unit 200 according to control of the controller 220 and then stored in a memory.

FIG. 4c is a view showing a method of analyzing a font type of a user terminal according to another embodiment of the present invention.

While an example of analyzing whether a font has a decoration at the vertical stroke, using an object extraction algorithm, is described in FIGS. 4a and 4b, an example of analyzing whether a font has a decoration at the vertical stroke by analyzing a pixel coordinate of the font is described in FIG. 4c.

The screen image provided by the user terminal 100 may be represented by a plurality of pixels arranged in a matrix form. Accordingly, the font type may be determined using a method of analyzing coordinate components, which indicate a font, of each pixel. For example, FIG. 4c shows a distribution of pixels constituting the small letter ‘m’ of SERIF. The controller 220 scans pixels included in a font region from left to right and extracts pixel coordinate values indicating the small letter ‘m’. The controller 220 classifies y-coordinates of the extracted pixel coordinates with respect to x-coordinates. For example, pixels indicating the small letter ‘m’ in an x-coordinate X₅ have y-coordinates Y₂ to Y₉, and the y-coordinates are continuous. In contrast, pixels (P1, P2) indicating the small letter ‘m’ in an x-coordinate X₄ have y-coordinates Y₃ and Y₉ and the y-coordinates are discontinuous. The y-coordinate component of the pixels indicating the small letter ‘m’ corresponds to a vertical strorke of the small letter ‘m’. Accordingly, when y-coordinates of pixels indicating ‘m’ that are classified with respect to x-coordinates are discontinuously distributed, the controller 220 determines that there are decorations at the starting point and the ending point of the font to determine the font type as SERIF.

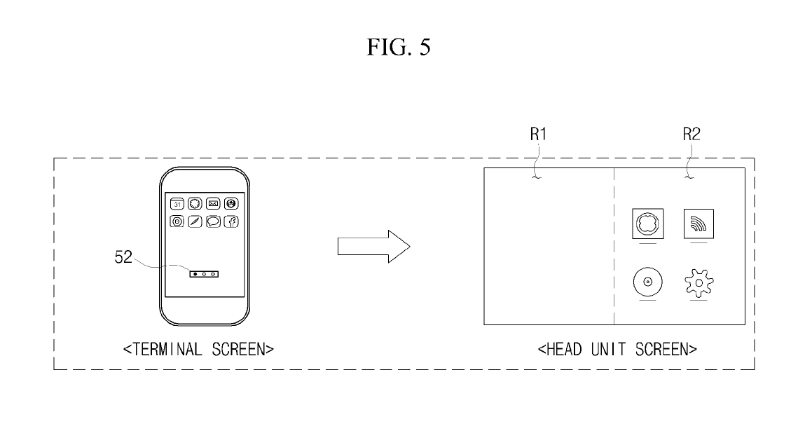

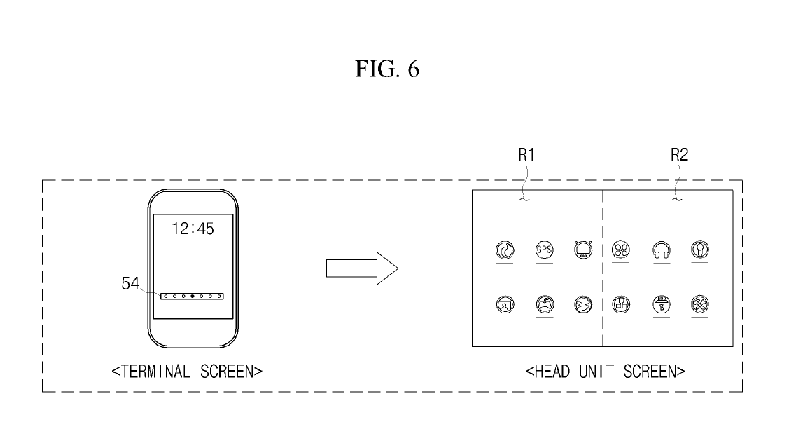

FIGS. 5 and 6 are views showing a process of analyzing an icon arrangement form of a user terminal to create a screen configuration of a head unit according to an embodiment of the present invention.

Referring to FIGS. 5 and 6, in an embodiment of the present invention, the controller 220 analyzes a page display icon 52 included in the screen image of the user terminal 100 set by the user to analyze the arrangement form of the icon based on the user preference. Here, each of the page display icons 52 and 54 indicates the number or positions of pages currently watched by the user through the user terminal 100 and specifically indicates the number of pages as dots, as shown in FIGS. 5 and 6. The controller 220 analyzes the page display icon 52 included in the screen image through the object extraction algorithm. For example, if the number of dots that indicate the page display icons 52 and 54 is less than a certain number, the controller 220 analyzes that the user prefers to simply arrange the screen of the user terminal 100 to display only frequently used icons. If the number of dots that indicate the page display icons 52 and 54 is more than a certain number, the controller 220 analyzes that the user prefers to complicatedly arrange the screen of the user terminal 100 to display even infrequently used icons. For example, as shown in FIGS. 5 and 6, the screen of the head unit 200 is equally divided into the first and second regions R1 and R2 in a vertical or horizontal direction. As a result of the analysis of the page display icon 52, if the number of pages is less than the certain number, as shown in FIG. 5, the controller 220 defines the screen configuration of the head unit 200 such that the icons to be displayed on the screen of the head unit 200 may be arranged in the first region R1 or the second region R2. In contrast, if the number of pages is more than the certain number, as shown in FIG. 6, the controller 220 defines the screen configuration of the head unit 200 such that the icons to be displayed on the screen of the head unit 200 may be arranged in the first region R1 or the second region R2. While an example of defining the screen configuration of the head unit 200 by analyzing the page display icon included in the screen image provided by the user terminal 100 has been described with reference to FIGS. 5 and 6, the screen configuration of the head unit 200 may be defined by analyzing the number of icons included in the screen image provided by the user terminal 100. For example, if the number of icons is less than the certain number, as in the head unit screen of FIG. 5, the controller 220 may define the screen configuration of the head unit 200 such that the icons to be displayed on the screen of the head unit 200 may be arranged in either the first region R1 or the second region R2. If the number of icons is more than the certain number, as in the head unit screen of FIG. 6, the controller 220 may define the screen configuration of the head unit 200 such that the icons to be displayed on the screen of the head unit 200 may be arranged in both the first region R1 and the second region R2.

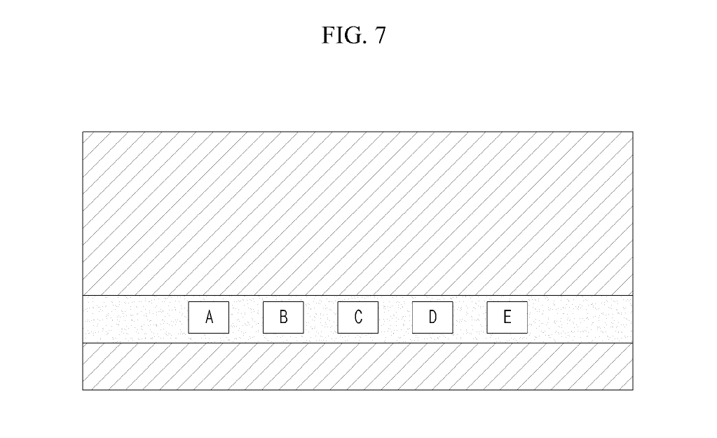

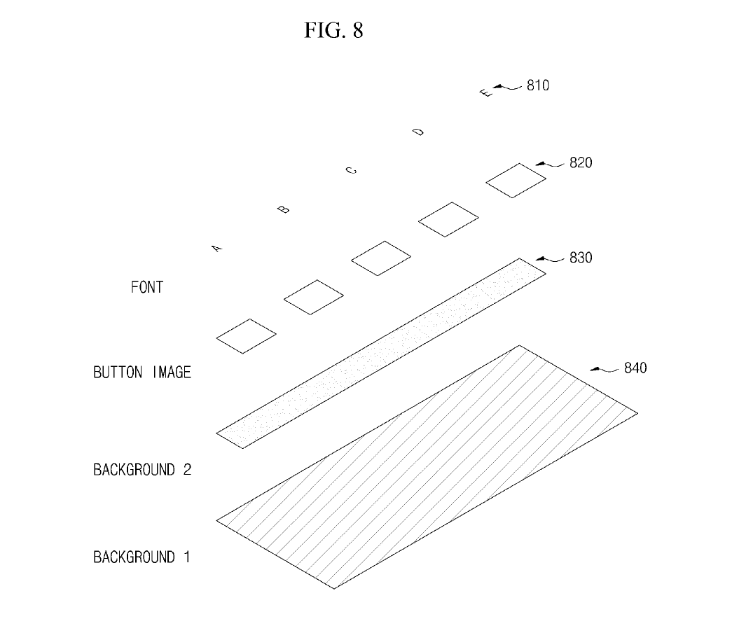

FIGS. 7 and 8 are views showing a process of creating a screen of a vehicle head unit using screen configuration elements determined according to an embodiment of the present invention. Specifically, FIG. 7 shows a complete screen of the head unit, and FIG. 8 shows a process of creating the complete screen of the head unit.

The controller 220 creates a layer for each screen configuration element defined according to the above-described method, in order to create the head unit screen as shown in FIG. 7. In FIG. 8, four layers are shown. As described with reference to FIGS. 3a to 4d, a first layer 810 includes some characters to be displayed according to a type and size of a font of the user terminal 100. A second layer 820 includes button icons to be used in the head unit screen. A third layer 830 and a fourth layer 840 include background colors of the user terminal 100. In FIG. 8, it is assumed that the number of background colors of the user terminal 100 is two. In this specification, a process of analyzing a background color of the screen image provided by the user terminal 100 to define the screen configuration elements of the head unit 200 has not been described, but can be sufficiently understood from the above description. For example, the controller 220 may extract the background color of the screen image by extracting a remaining region other than the icons and characters in the screen image provided by the user terminal 100 to analyze the RGB values of the extracted remaining region. If the number of background colors of the user terminal 100 is more than 3, only two colors may be defined as the screen configuration elements of the head unit 200 in descending order of distribution through histogram analysis. In this case, as shown in FIG. 8, a first color having high distribution defines a layer 840 for forming a background color of the head unit screen, and a second color having relatively low distribution a layer 830 for forming a color or an ambient color of the icon to be displayed in the head unit screen. The layers 810, 820, 830, and 840 are synthesized through the controller 220 of FIG. 2 and the video processor 224 of the controller 220 to create the complete head unit screen as shown in FIG. 7. The created head unit screen is displayed to a user inside a vehicle through the display unit 260 of FIG. 2 according to control of the controller 220 or the video processor 224 of the controller 220.

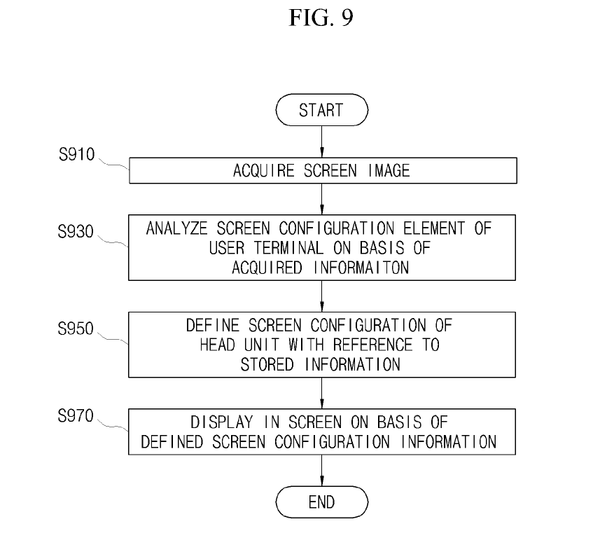

FIG. 9 is a flowchart showing a method of setting a screen of the vehicle head unit according to an embodiment of the present invention. The description thereof will be provided with reference to FIG. 2. Unless stated otherwise, it is assumed that what performs the below described operations is the vehicle head unit 200 shown in FIG. 2.

Referring to FIG. 9, first, in operation S910, the method acquires a screen image that is obtained by capturing the screen of the user terminal 100. Next, in operation S920, the method analyzes a screen configuration element associated with a preference of the user in the acquired screen image, and stores the screen configuration element.

Next, in operation S930, the method defines the screen configuration of the head unit 200 with reference to the stored screen configuration element. For example, among the screen configuration elements that are defined in the head unit 200, the font size may be determined in consideration of a weight obtained by qualifying a proportional relation between the average distance from the eyes of the user to the user terminal 100 and the average distance from the eyes of the user to the head unit 200 installed inside the vehicle, and the font type may be determined on the basis of a vertical stroke component among stroke components included in the font. In addition, among the screen configuration elements that are defined in the head unit 200, the icon arrangement may be determined by analyzing a page display icon included in the screen image provided by the user terminal 100. Here, the page display icon may be an icon that indicates the number or positions of the pages of the screen of the user terminal 100.

In operation S950, the method determines the screen configuration of the head unit screen on the basis of the screen configuration of the head unit 200 defined in S930, and stores the determined screen configuration.

Next, in operation S970, the method creates the head unit screen with reference to the screen configuration stored in the memory and displays the head unit screen through the display unit.

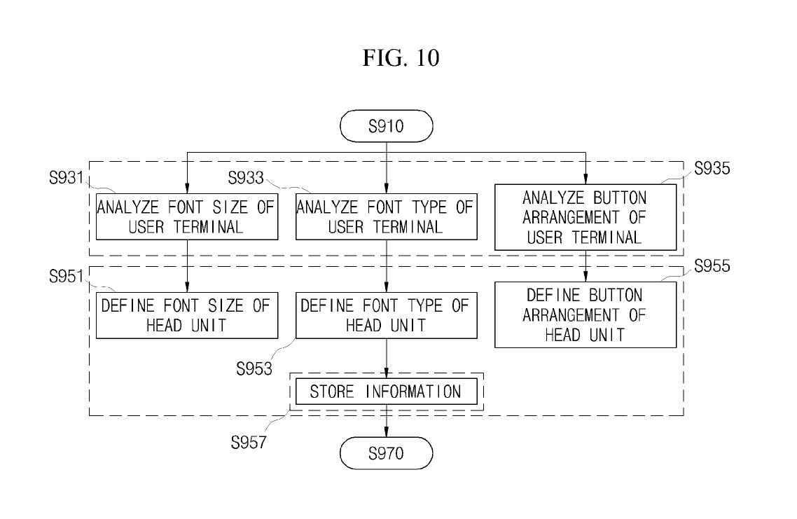

FIG. 10 is a flowchart showing in detail operations S930 and S950 shown in FIG. 9.

Referring to FIG. 10, operation S930 is a process of analyzing a screen configuration element of the user terminal 100, and may include at least one of analyzing the font size of the user terminal according to the method described in FIGS. 3a to 3c in operation S931, analyzing the font type of the user terminal according to the method described in FIGS. 4a to 4c in operation S933, and analyzing the icon arrangement of the user terminal 100 according to the method described in FIGS. 5 and 6 in operation S935.

In operation S950, according to a result of the analysis in S930, the method determines a screen configuration element of the head unit 200 and stores the screen configuration element. The determining of a screen configuration element of the head unit 200 includes determining the font size of the head unit 200 according to a result of the analysis in operation S931, determining the font type of the head unit 200 according to a result of the analysis in operation S933, and determining the icon arrangement of the head unit 200 according to a result of the analysis in operation S935. In operation S957, the screen configuration elements of the head unit 200 determined in operations S951, S953, and S955 are stored in a memory of the head unit 200. Subsequently, the method displays the head unit screen by using the screen configuration elements of the head unit 200 stored in the memory.

Accordingly, according to the present invention, it is possible to avoid the inconvenience that the user should newly set the screen of the head unit 200 whenever synchronizing the screen of the head unit with the screen of the use terminal and to receive the screen configuration of the user terminal which is set by a user according to a preference of the user through the vehicle head unit to receive a user experience (UX) interface specialized to the user.

The vehicle head unit and the method of setting a screen of the vehicle head unit according to the present invention may not be applied only to the configurations and methods of the above embodiments, which may be configured to have various modifications by selectively combining all or several of the embodiments.

What is claimed is:

1. A vehicle head unit for displaying a screen configuration of a user terminal, the vehicle head unit comprising:
a controller configured to analyze a screen configuration element associated with a preference of a user from a screen image obtained by capturing a screen of the user terminal and create a screen configuration of the vehicle head unit with reference to the analyzed screen configuration element; and
a storage unit configured to store the screen configuration of the head unit according to control of the controller.

2. The vehicle head unit of claim 1, wherein the controller analyzes the screen configuration element including at least one of a background color, an icon color, an icon arrangement, and a font type of a remaining region other than an icon region and a font region included in the screen image.

3. The vehicle head unit of claim 2, wherein the controller creates the screen configuration of the vehicle head unit including the icon or the font having a size adjusted according to a predetermined weight.

4. The vehicle head unit of claim 3, wherein the weight is a value obtained by quantizing a proportional relation between the distance from the eyes of the user to the user terminal and the distance from the eyes of the user and the vehicle head unit installed in the vehicle.

5. The vehicle head unit of claim 2, wherein the controller analyzes a vertical stroke component among stroke components included in the font, determines the font type according to the preference of the user, and create the screen configuration of the head unit including the determined font type.

6. The vehicle head unit of claim 5, wherein the controller determines the font type as SANS SERIF if the stroke component is continuously extended in a vertical direction, and determines the font type as SERIF if the stroke component is discontinuously extended in a vertical direction.

7. The vehicle head unit of claim 2, wherein the controller defines a background color analyzed from the screen image as a background color of the screen configuration of the vehicle head unit, a color of the icon, or an ambient color of the icon.

8. The vehicle head unit of claim 7, wherein the background color analyzed from the screen image includes a first color and a second color, and
the controller defines the first color as a background color of the screen of the vehicle head unit and defines the second color as a color of the icon or an ambient color of the icon.

9. The vehicle head unit of claim 2, wherein the controller analyzes a page display icon indicating the number of pages included in the screen image to analyze arrangement of the icon according to the preference of the user, and
the page display icon indicates the number or positions of pages of the screen of the user terminal.

10. The vehicle head unit of claim 9, wherein the controller equally divides the screen of the vehicle head unit into first and second regions in a vertical or horizontal direction,
creates the screen configuration of the vehicle head unit such that icons to be displayed in the screen of the vehicle head unit are arranged in both the first region and the second region if the number of pages is more than a certain number, and
creates the screen configuration of the vehicle head unit such that the icons to be displayed in the screen of the vehicle head unit are arranged in either the first region or the second region if the number of pages is less than the certain number.

11. The vehicle head unit of claim 2, wherein the controller analyzes the number of the icons included in the screen image to analyze arrangement of the icons according to the preference of the user.

12. The vehicle head unit of claim 11, wherein the controller equally divides the screen of the vehicle head unit into first and second regions in a vertical or horizontal direction,
creates the screen configuration of the vehicle head unit such that icons to be displayed in the screen of the vehicle head unit are arranged in both the first region and the second region if the number of icons is more than a certain number, and
creates the screen configuration of the vehicle head unit such that the icons to be displayed in the screen of the vehicle head unit are arranged in either the first region or the second region if the number of icons is less than the certain number.

13. A method of setting a screen of a vehicle head unit, the method comprising:
analyzing a screen configuration element associated with a preference of a user from a screen image obtained by capturing a screen of the user terminal; and
creating a screen configuration of the vehicle head unit using the analyzed screen configuration element.

14. The method of claim 13, wherein the screen configuration element includes at least one of a background color, an icon color, an icon arrangement, and a font type of a remaining region other than an icon region and a font region included in the screen image.
